(19) United States
(12) Patent Application Publication
(10) Pub. No.: US 2026/0185722 A1
(43) Pub. Date: Jul. 2, 2026

(54) METHOD FOR PRODUCING A WALL HEATING SYSTEM, A HEATING WALLPAPER AND HEATING INK MIXTURE AND AN INKJET PRINTER WITH A HEATING INK

(71) Applicant: Hennes Röseler, Rostock (DE)

(72) Inventor: Hennes Röseler, Rostock (DE)

(21) Appl. No.: 19/121,763

(22) PCT Filed: Jul. 26, 2023
(86) PCT No.: PCT/DE2023/000079

§ 371 Date: Apr. 16, 2025

(30) Foreign Application Priority Data
Jul. 26, 2022 (DE) 102022118724.1

(51) Int. Cl. F24D 13/02; B41M 3/00; B41M 3/18; C09D 11/52; E04F 13/00; H05B 3/14; H05B 3/34

(52) U.S. Cl. CPC F24D 13/024; B41M 3/006; B41M 3/18; C09D 11/52; E04F 13/002; H05B 3/145; H05B 3/34; H05B 2203/017

(57) ABSTRACT

A method for producing a wall heating system by determining a printed image of heating surfaces on a heating wallpaper, gluing the heating wallpaper to a wall and connecting the heating wallpaper to an electrical voltage. The printed image is supplied to the control system of an inkjet printer, the control system controls at least one printhead, at least one container connected to the printhead in an ink-conducting manner is filled with heating ink, and the heating ink is printed along the heating surfaces of the heating wallpaper.

The invention relates to a method for producing a wallpaper heating system by measuring an area to be heated, determining a printed image made of heating surfaces on the basis of the determined dimensions on the wallpaper, gluing the wallpaper to the heating surface and connecting the wallpaper to an electrical voltage. The invention also relates to a heating ink mixture according to the preamble of claim 13, a heating wallpaper according to the preamble of claim 18 as well as an inkjet printer according to the preamble of claim 21.

The costs of heating rooms, in particular living spaces, are constantly increasing. In addition, heat generation requires raw materials such as heating oil or gas, which are used up over time. The procurement of such raw materials is therefore becoming increasingly problematic and costly.

In principle, the situation is improved by electric heaters, since electricity can also be generated from renewable energy sources such as wind power, hydropower or photovoltaics.

Electric wall or floor heating systems are already known in the state of the art. For example, from DE 10 2008 002 826 A1. A floor heating system with an electric heat-conducting layer is presented there. The heat-conducting layer comprises conductive paths. One layer after another is successively applied to the floor. The method is relatively expensive and not really suitable for wall heating in residential spaces.

Therefore, an aim of the present invention is to provide a method for producing a wall heating system that is both cost-effective and flexible in use.

Another aim of the present invention is to provide a heating ink mixture that is suitable for the aforementioned method.

Another aim of the present invention is to provide a heating wallpaper that can be produced in a cost-effective manner.

The fourth aim of the invention is to provide an inkjet printer that can be used to carry out the aforementioned method. The inkjet printer operates using bubble jet technology and UV-curing processes.

The invented method is used to produce a wall heating system. The term “wall heating system” has a very general meaning here. In particular, it can also refer to ceiling heating or floor heating, as well as to the heating of other surfaces such as vehicle interiors. In particular, the walls or ceilings may have openings such as windows, doors or the like, which may be curved, straight or have a horizontal, vertical or continuous shape.

In a preferred embodiment, the wall to be heated is measured, namely the height and width of the wall on which the heating system will be installed are measured. In addition, the dimensions of openings such as doors and windows are also measured and their position on the wall is established. The method is however also suitable for printing and producing standardized wallpapers that do not require measurements in advance and may be cut to fit the wall on site.

The dimensions are determined and a printing image made of heating surfaces is established on the heating wallpapers on the basis of these dimensions. The heating wallpaper is printed and glued to the wall. The term “heating wallpaper” also has a broad interpretation. A wallpaper is primarily conceived as a support layer, which may consist of several strips. However, a wallpaper can also be based on external dimensions that already correspond to the outer dimensions of the wall, so that after cutting out the doors and windows and other openings, the wallpaper can be glued to the wall in one piece. Heating surfaces in the form of stripes or other desired shapes are printed onto the wallpaper and the heating wallpaper is produced. The printed image of the heating wallpaper is determined in advance on the basis of the dimensions of the wall to be heated.

The heating wallpaper is connected to an electric voltage, preferably to a low voltage of 12V or 24V. The voltage can also be scalable from 5V to 48V. For this purpose, the heating surfaces are equipped with electrical connections that preferably protrude from the wallpaper at the bottom end. The electrical connections may be covered by a skirting board that extends along the wall at the bottom. The connections can also be covered by any surface or be located in the inner corner between any surfaces.

According to the invention, the printing image is fed to the controller of an inkjet printer. The controller controls at least one printhead. The ink-conducting printhead is connected to a container filled with heating ink. The heating ink is printed onto the heating wallpaper along the heating surfaces using an inkjet printer.

Inkjet printers enable the application of a very homogeneous heating layer, whose thickness remains consistent across the entire printed surface.

By using an inkjet printer, the thickness of the ink layer remains consistent across the entire heating surface printed, whereby the maximum deviations in the heating layer thickness range between 3% and 7% of the average layer thickness of the respective heating surface. The layer thickness itself lies in the micrometer range.

It has been found that screen printing processes generate a more uneven layer thickness than inkjet printing processes. Since current flows through the heating ink through the electrical voltage connection during operation, generating heat that is used to heat the room, the thickness of the heating layer plays a significant role. The thicker the heating layer, the higher the temperature generated at that point with the same voltage. The non-homogeneous application of the heating ink can therefore lead to a very uneven distribution of the temperature along the wall or even cause burn marks on the heating wallpaper, if the layer is applied too thick.

In a preferred embodiment of the invention, an additional container is filled with another heating ink. The additional container is connected to another ink-conducting printhead and the additional heating ink is used to print conducting paths along the edges of the heating surfaces.

The additional heating ink can be configured identically to the heating ink. Therefore, the additional printhead may also coincide with the printhead and the additional container may also coincide with the container.

In principle, one printhead can also be used to print consecutively with different inks, preferably heating inks. Preferably, the heating ink is printed first and then the additional heating ink is printed with the same printhead or vice versa.

The conducting paths, that preferably extend along the edges of the heating surfaces, can also be printed with an additional carbonic heating ink. The additional heating ink can differ from the heating ink used to print the heating surfaces themselves. However, they can also be identical. Preferably, the conducting paths made of additional heating ink are printed with an additional printhead, while the heating surface itself is printed with heating ink.

Before or after this, heating ink is preferably printed with the printhead onto the heating surfaces, conveniently over the already printed or yet to be printed conducting paths also. The heating ink applied on the conducting paths is therefore thicker than the one applied on the heating surfaces and the conducting paths conduct electricity better due to the thicker layer.

Preferably, the conducting paths are glued to the heating wallpaper by applying an adhesive layer to the heating wallpaper and a carbonic conductive layer to the adhesive layer.

Other methods involve gluing the conducting paths and preferably printing the heating ink thereafter.

Conveniently, carbonic powder can also be sprinkled onto the adhesive layer. Excess carbonic powder can then be blown or vacuumed away.

In these embodiments, the conducting paths are not printed but produced separately by adhesion or optional scattering. After applying the conducting paths, the intermediate product can be inserted into the inkjet printer in order to print heating ink onto the heating surfaces.

Preferably, the conducting paths are equipped with electrical connectors for the power supply. The electrical connectors can be printed into the conducting paths during the printing process. They can also be glued to the conducting paths using a conductive compound or similar means.

In a particularly preferred embodiment of the invented method, a container of a printhead is filled with nanotetrapods. Preferably, a third container is connected to a third printhead in a nanotetrapod-conductive manner. A nanotetrapod layer is printed onto the heating surface with the third printhead. The nanotetrapod layer can also be printed first onto the heating surface and the heating ink can then be printed over the nanotetrapod layer. This improves the adhesion of the heating ink to the wallpaper.

The nanotetrapods can be zinc oxide nanotetrapods or carbonic nanotetrapods. Zinc oxide nanotetrapods improve the adhesion of the subsequently applied heating ink layer to the wallpaper, while carbonic nanotetrapods increase the conductivity of the heating layer.

In a preferred embodiment, heating ink is printed onto the entire surface of the heating wallpaper, so that the wall is completely covered with heating ink. The fully printed heating wallpaper created a shielding wallpaper.

If the entire surface of the wallpaper is printed with heating ink, a Faraday cage can be created, if the wallpaper is applied on all walls and the ceiling, and possibly even the floor. The thickness of the full-surface, shielding heating layer is preferably a few micrometers, 5-100 μm, and can be expanded to a maximum of 3 mm depending on the use. Transitions between individual wallpaper strips can be closed with backing strips, as can transitions to building components such as windows, doors and other surfaces. The following shielding values were determined during experiments. 20
Radio TETRA 470 MHz: 36 dB
D-network, GSM 900 MHz: 36 dB
E-network, GSM 1800 MHz: 36 dB
Bluetooth, WLAN 2450 MHz: 36 dB
X-band radar 9.5 GHZ: 43 dB
KU-band radar 15 GHz: 42 dB

According to the table for the conversion of the attenuation from dB into %, this corresponds to a transmission of 0.02-0.01%. Thus, 99.98% of the electromagnetic radiation is shielded by a heating wallpaper whose entire surface is printed with heating ink, if all walls and the ceiling of a room are completely covered with such a heating wallpaper. The shielding value can further be improved and reach 80 dB by inserting metal mesh into the flooring, preferably by filling it in.

In a particularly preferred embodiment of the invented method, conducting paths are printed onto the wallpaper from the power connections to connection points in the heating wallpaper for electrical devices.

Additional functions can also be integrated into the wallpaper during the printing process. Connection points can thus be integrated when printing wall designs. It is therefore possible to print temperature sensors, USB ports, connection points for room thermostats, lighting and other applications.

For example, a temperature sensor may be printed using a mixture that develops a different electrical resistance when the temperature changes. This value then determines the corresponding temperature. In the formula, carbon components of the heating ink mixture are replaced with semiconductors such as oligoacenes or phthalocyanines and a formula for a sensor is created. After printing the formula for the sensor, a reference surface is measured. This determines which electrical resistance is generated at which temperature. The design of the printed sensor is then established. The printed sensor may be covered with isolation and the heating ink may be printed over it. During operation, the sensor detects the temperature of the heating ink. The temperature is measured via a resistance measurement of the sensor. The sensor is integrated into a temperature control system and the temperature is displayed digitally.

Insulation can be printed between crossing conducting paths. This prevents short circuits in the cable routing. For this purpose, the carbon components and the conductivity enhancers are removed from the aforementioned formula and replaced with aluminum oxide.

Magnetic properties can also be integrated into the wallpaper by adding magnetite. This can also be used to print sensors for corresponding applications.

The second aspect of the problem is solved by a liquid heating ink mixture that has the characteristics specified in claim 13.

The heating ink mixture is in a liquid aggregate state. To prepare the mixture, the individual components are preferably added to water with constant stirring until they dissolve and then poured in liquid form into the containers of the inkjet printer described below or used in one of the aforementioned methods.

The weight percentages refer to the mass of water, including the components dissolved in it. The weight percentages refer to the finished, liquid heating ink mixture. In its simplest form, the heating ink mixture consists of carbon, binder and anti-foaming agent as well as nanotetrapods and water. The percentages of components are defined by intervals that lie between an upper and a lower limit.

For example, the upper limit of the carbon concentration interval is 90, 80, 70, 60, 55, 50, 45 or 40% w/w. The lower limit may be 0.05, 0.1, 0.2, 2, 4 or 5% w/w. This application includes all intervals that exist on the basis of all possible consistent combinations that can be made between the aforementioned upper and lower limits.

For example, the upper limit of the binder concentration interval is 40, 38, 35, 30, 25 or 20% w/w. The lower limit may be 0.05, 0.1, 0.2, 0.5, 1.0, 2.0, 3.0 or 5.0% w/w. This application includes all intervals that exist on the basis of all possible consistent combinations that can be made between the aforementioned upper and lower limits.

For example, the upper limit of the anti-foaming agent concentration interval is 5, 4, 3 or 2% w/w. The lower limit may be 0.02, 0.03, 0.05, 0.1 or 1.0% w/w. This application includes all intervals that exist on the basis of all possible consistent combinations that can be made between the aforementioned upper and lower limits.

For example, the upper limit of the water concentration interval is 90, 85, 80, 75, 70, 65, 60 or 55% w/w. The lower limit may be 40, 45, 50, 55, 60 or 65% w/w. This application includes all intervals that exist on the basis of all possible consistent combinations that can be made between the aforementioned upper and lower limits.

For example, the upper limit of the nanotetrapods concentration interval is 60, 55, 50, 45 or 40% w/w. The lower limit may be 0.05, 0.1, 2, 3, 4 or 5% w/w. This application includes all intervals that exist on the basis of all possible consistent combinations that can be made between the aforementioned upper and lower limits.

This application includes a combination of the aforementioned intervals, provided that the sum of the components equals 100% w/w.

The heating ink mixture is liquid and suitable for use in an inkjet printer.

The carbon may be present in the form of graphite, soot, graphene, graphyne or carbon nanotubes or nanotetrapods or in other forms. With regard to the formation and properties of carbon nanotubes, reference is made to the article: Carbon Nanotubes: Properties and Application, Materials Science and Engineering: R: Reports, Volume 43, Issue 3, Jan. 15, 2004, pages 61-102, by Valentin N. Popov.

The graphite may be present in the form of various graphite modifications such as expanded graphite flakes, foil graphite, natural graphite or synthetic graphite. The proposed invention can be realized with a variety of different graphite variants. Graphene can also be present in various forms: pure graphene, periodically stacked superlattice, double-layered superlattice, nanoplatelets, flakes or even powder.

A cationic latex-based binder such as butanol NX4190 can be used as binder. Several experiments were conducted with butanol NX4190 in concentrations ranging from 1 to 12% w/w and it has been discovered that the higher the concentration, the better the adhesion of the heating ink to smooth surfaces.

Foam-Star SI 2210 or Foam-Star SI 2213 from the company BASF were used as anti-foaming agent. This anti-foaming agents were specially developed for printing ink, adhesives and UV-curing systems and prevent foaming while mixing the components.

According to the invention, carbon nanotetrapods are added to the heating ink mixture. Nanotetrapods are three-dimensional bodies with four arms that extend in four different directions. They allow the heating ink to interlock with the wallpaper on which the heating ink is printed, so that the amount of binding agent can be reduced.

Nanotetrapods are known in the state of the art. See: Xin Jin, Jan Strueben, Lars Heepe, Alexander Kovalev, Yogendra K. Mishra, Rainer Adelung, Stanislav N. Gorb, Anne Staubitz: Joining the Un-Joinable: Adhesion Between Low Surface Energy Polymers Using Tetrapodal ZnO Linkers. In: Advanced Materials: published online on Aug. 24, 2012, DOI 10.1002/adma.201201780.

The nanotetrapods are preferably zinc oxide nanotetrapods or carbon nanotetrapods. In addition to mechanically improving the adhesion of the heating ink to the wallpaper, carbon nanotetrapods in particular also increase the conductivity of the heating ink.

According to the invention, at least a part of the carbon is added to the heating ink mixture in the form of carbon nanotetrapods. Preferably, the entire carbon concentration of the heating ink mixture consists of carbon nanotetrapods. However, only a part of the carbon may be present in the form of carbon nanotetrapods, while the remaining carbon concentration is present in one of the other forms already mentioned.

Preferably, the wallpaper shall be made of nonwoven fabric, in particular nonwoven cellulose material, nonwoven glass fiber material, nonwoven polyester material as well as mineral-based nonwoven fabric, which have a high dimensional stability. However, paper can also be used, although it has the disadvantage of swelling during the application of the heating ink.

The weight percentage of the nanotetrapods ranges from 0.05 to 60% w/w and can constitute the entire carbon concentration if the nanotetrapods are present in the form of carbon nanotetrapods. The nanotetrapods can also make up a smaller percentage of the carbon concentration, so that in addition to the carbon nanotetrapods, carbon may also be present in the heating ink mixture in the form of graphite, soot, graphene or carbon nanotubes. The sum of all weight percentages is equal to 100%.

In a preferred embodiment of the heating ink mixture, the heating ink mixture contains between 1 and 5% w/w anti-settling agent. The concentration of the anti-settling agent is defined by an upper and a lower limit. For example, the upper limit may be 5, 4.5, 4, 3.5 or 3% w/w and the lower limit may be 0.01, 0.02, 0.03, 0.05, 0.1, 0.2, 0.5, 0.7, 1.0, 2.0 or 3.0% w/w. This application includes all intervals that exist on the basis of all possible consistent combinations that can be made between the aforementioned upper and lower limits.

The anti-settling agent prevents the settling of particularly large carbon particles during the mixing of the heating ink by adding water. The heavy carbon particles or other heavy particles usually settle at the bottom of the heating ink. The anti-settling agent prevents this. For example, Efka 1506 was used as anti-settling agent. This is a polyolefin wax thicker marketed by the company BASF.

In a preferred embodiment of the heating ink mixture, 1 to 5% w/w flow enhancer was added. For example, the upper limit may be 5, 4.5, 4, 3.5 or 3% w/w and the lower limit may be 0.01, 0.02, 0.03, 0.05, 0.1, 0.2, 0.5, 0.7, 1.0, 2.0 or 3.0% w/w. This application includes all intervals that exist on the basis of all possible consistent combinations that can be made between the aforementioned upper and lower limits.

A fluorocarbon-modified polyacrylate marketed by the company BASF under the trade name Efka FL 3772, whose main component is Butan-2-ol was used as flow enhancer.

In a preferred embodiment of the heating ink mixture, 1 to 5% w/w conductivity enhancer was added to the mixture. For example, the upper limit may be 5, 4.5, 4 or 3% w/w and the lower limit may be 0.1, 0.2 or 0.3% w/w. The conductivity enhancer marketed by the company BASF under the trade name Efka IO 6782, whose main component is isobutanol, was used as conductivity enhancer.

The third aspect of the problem is solved by a heating wallpaper with the characteristics mentioned in claim 18.

The invented heating wallpaper includes a support sheet and at least two conducting paths between which a heating surface is located. The whole heating surface is printed with heating ink made of one of the ink mixtures described above. Additional components, such as pressure detectors and pressure structures as well as temperature sensors and temperature limiters, can also be included on the heating surface. The heating wallpaper is also an essential component of the wall heating system described at the beginning. What has been written about the wall heating system and the heating ink also applies to the heating wallpaper.

Conveniently, the conducting paths are applied to the support sheet and the heating ink is printed over the conducting paths.

Electrical low-voltage connectors are preferably mounted at the end of the conducting paths.

The fourth aspect of the problem is solved by an inkjet printer with the characteristics mentioned in claim 21.

The inkjet printer has a printhead that conducts ink from a container that is filled with heating ink made of one of the aforementioned heating ink mixtures according to the invention.

The embodiments of the invention are illustrated in three figures as follows:

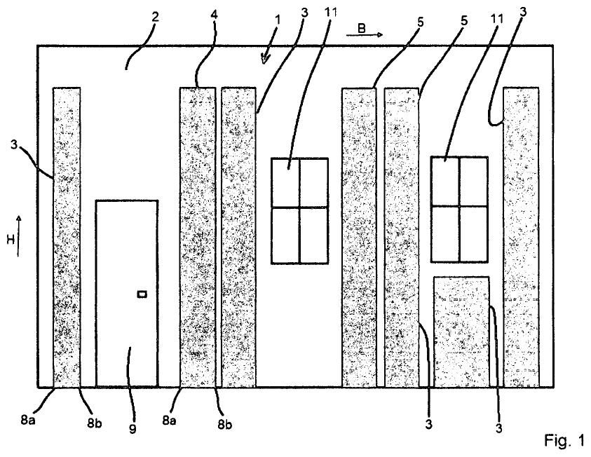

FIG. 1—A wallpaper printed with heating ink that is glued to a wall.

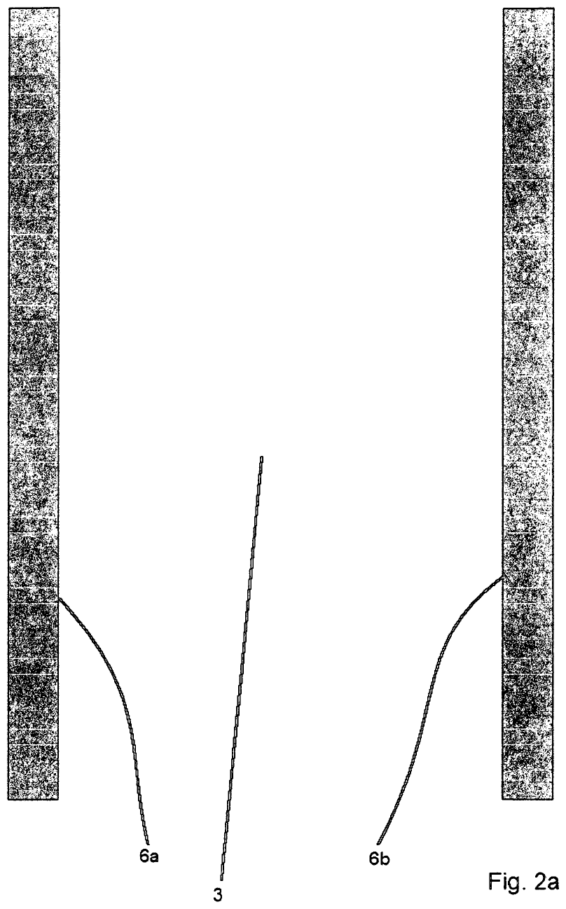

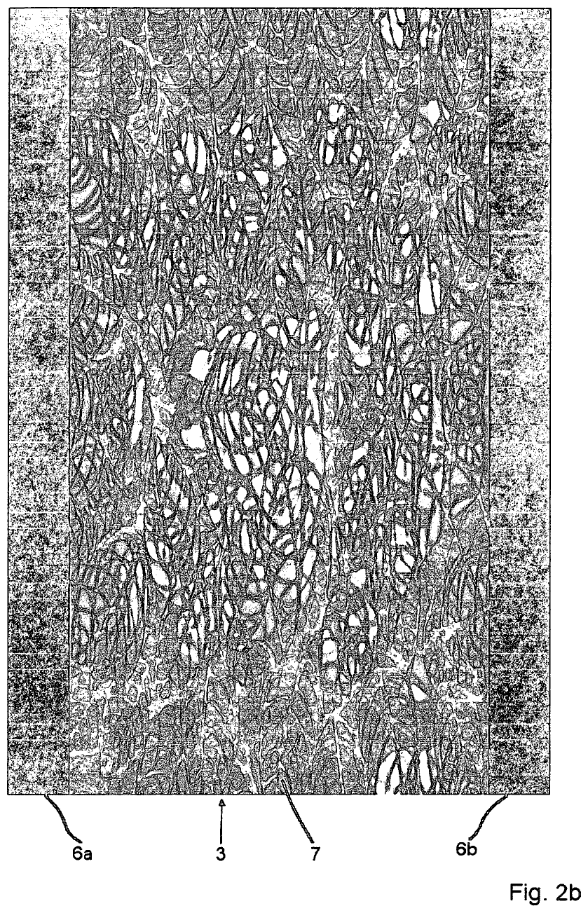

FIG. 2a—Print pattern of a first printing process for printing two straight conducting paths.

FIG. 2b—Print pattern of a second printing process for printing a net-shaped conducting path pattern.

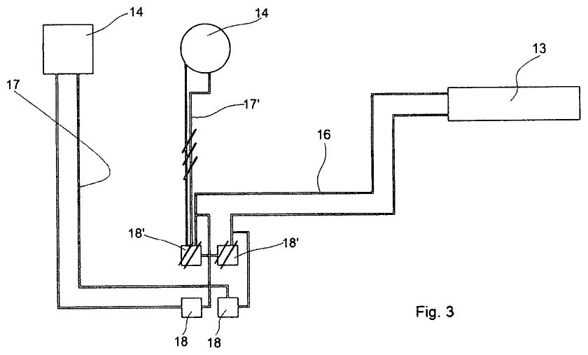

FIG. 3—Schematic drawing of the invented inkjet printer.

FIG. 1 shows a schematic illustration of a heating wallpaper 2 that is glued to a wall 1. The heating wallpaper 2 has seven heating surfaces 3, all with a rectangular shape. All heating surfaces 3 are printed over their entire surface with heating ink 4. This forms a heating layer 5. In addition, the individual heating surfaces 3 are printed with straight lateral conducting paths 6a, 6b as shown in FIG. 2a and a net-shaped conducting path pattern 7 as shown in FIG. 2b. However, the conducting paths are not visible in FIG. 1 because they are completely covered by the heating ink 4. The heating wallpaper 2 shown in FIG. 1 is printed in one piece using an appropriately dimensioned inkjet printer. However, the heating wallpaper 2 shown in FIG. 1 can also consist of several long wallpaper pieces, e. g. wallpaper strips, which are individually printed and then put together to form the heating wallpaper 2.

The support of the heating wallpaper 2 is made of nonwoven fabric, which is first printed with the conducting paths 6a, 6b, 7 in two steps as shown in FIG. 2a, 2b and then with heating ink 4 over the entire heating surfaces.

Two electrical connectors 8a, 8b are provided for each heating surface 3 at a lower end of the heating surfaces 3. The electrical connectors 8a, 8b are connected to a low-voltage supply of 5 volts to 48 volts. The voltages can be stepped down from a 220V household network or can come directly from photovoltaic systems or other power sources with stored electricity or can also be stepped down or up from there. The cables and wiring are not represented. The standard household voltage of 220 volts is stepped down to the required low voltage of approximately 12 volts or 24 volts with a transformer.

After gluing the heating wallpaper 2 to the wall 1 and wiring it, the wall heating system shown in FIG. 1 is formed. Such a heating system can, of course, also be installed on the floor or ceiling. The term “wall 1” therefore refers to a general surface.

In order to produce the wall heating system, the wall 1 shown in FIG. 1 shall be measured. For this purpose, the external dimensions of wall 1, i.e. height and weight as well as the dimensions and positions of the door opening and both window openings, shall be determined. A roll of wallpaper with a width corresponding to the height of the wall is then inserted into an appropriately dimensioned inkjet printer (not shown). The inkjet printer has a control system that enables the programming of a print pattern for each individual printhead. The openings for door 9 and window 11 can be cut out subsequently. The opening dimensions of window 11 and door 9 can also be printed onto the heating wallpaper 2 with one of the printheads.

The printheads run in the inkjet printer along a longitudinal direction that corresponds to the height H of wall 1. Each printhead prints its programmed print pattern in narrow stripes, one after the other, onto the support inserted into the inkjet printer. The first printhead prints conducting paths 6a, 6b as shown in FIG. 2a onto the support in longitudinal direction. A second printhead prints the net-shaped conducting path pattern 7 as shown in FIG. 2b onto the support over the first printed pattern. A third printhead prints a uniform layer of heating ink over the net-shaped conducting path pattern 7 shown in FIG. 2a.

The conducting paths 6a, 6b, 7 shown in FIGS. 2a and 2b may be printed with the heating ink described below. However, the conducting paths 6a, 6b, 7 can also be printed with a different ink.

The conducting paths 6a, 6b can also be applied in a two- or multi-step process, preferably using two or more printheads. First, an adhesive layer is applied using a first printhead and in a second retrograde step, a carbonic layer or a pure carbon layer is applied on the adhesive layer. The carbon layer or carbon-containing layer can be sprinkled onto the adhesive layer in powder form using a second printhead or a separate printer. Excess carbon is then vacuumed or blown away.

Carbon can be applied on the adhesive layer in different states: as a graphite layer which is applied with its molecular lattice structure parallel to the surface, as a soot layer, as a graphyne layer or as a graphene layer. Graphene is very conductive and is preferably applied on the support using adhesive tapes, i.e. not by a printing process. In principle, the conducting paths can also be applied without using the inkjet printer, for example, by applying adhesive along the positions of the conducting paths and then sprinkling an electrical conductor over the adhesive layer, for example, one of the aforementioned carbonic compounds: graphene, soot, graphite or graphyne. In addition to powder form, graphene can also be applied over the surface in the form of tape.

Regardless of how the conducting paths are applied, the optional net-shaped conducting path pattern 7 shown in FIG. 2b is applied over them using a second printhead. This conducting pattern is intended to subsequently even out the radiation pattern during heat distribution. The conducting path pattern 7 can have various configurations; it can also be vein-like or otherwise branched or net-shaped. The conducting path pattern 7 can be printed over the entire heating surface 3. It can also vary along the heating surface 3. For this purpose, adhesive strips are applied to the wallpaper in a predetermined pattern and then powder is sprinkled over them, as described above. The conductive heating ink can also be printed in the net-shaped conducting path pattern 7 onto the heating surfaces 3 with the inkjet printer.

In the illustrated embodiment, the heating ink 4 is printed over the entire heating surfaces 3 using a third printhead. The thickness of the heating layer 5 is preferably a few micrometers, 5-100 μm, and can be expanded up to 3 mm depending on the use. However, other thicknesses are also possible. In principle, the thickness of the heating layer 5 depends on the heating requirements. The thicker the heating ink 4 is applied, the hotter the heating surface 3 becomes at the same voltage applied to the electrical connectors 8a, 8b. However, the heating layer 5 has a very uniform thickness over the entire heating surface 3, which only varies by 1-3 μm.

A series of experiments were conducted with the inkjet printer HP LX850.

The following formula was used as heating ink 4:

The formula can also be prepared from anionic elements.

The components of heating ink 4 were dissolved individually in water and stirred with an electric stirrer while continuously adding the solutions.

First, the binder butanol MX 4190 from the company BASF was added. This is a cationic styrene-butadiene binder. Various experiments were conducted, with amounts ranging from 1 to 12% w/w.

The anti-foaming agent Foamstar SI 2210 or Foamstar SI 2213 was then added to the mixture in amounts ranging from 0.02 to 5% w/w.

Initially, the inventors discovered that the higher the binder amount, the better the adhesion of the heating ink 4 to the nonwoven wallpaper. Unfortunately, the electrical conductivity of the heating layer 5 also decreases thereby. To solve this problem, the amount of binder was reduced and zinc oxide nanotetrapods were added. The zinc oxide nanotetrapods further improve the adhesion of the heating ink 4 to the nonwoven fabric of the heating wallpaper. In order to improve the electrical conductivity of the heating wallpaper 2, carbon was added to the mixture in an amount of 0.05 to 60% w/w. Carbon was added in the form of graphite or soot. Nanographene was also added and exhibited a very good conductivity.

In another experiment, Tuball Latex H₂O, a suspension of carbon nanotubes marketed by the company OCSIAL under this trade name, was also added.

It has been found that the concentration of the conductive components should range between 0.01 and 60% w/w. If the concentrations are higher, the liquid becomes too thick. The binder should not exceed 25% w/w, otherwise the conductivity will be reduced. The aforementioned butanol NX 4190, but also FK 106782 or FK 106780, which are sold by the company BASF, were used as binders.

It has proven advantageous to add an anti-settling agent to the mixture. Efka RM 1506 from the company BASF was used for this purpose. The inventors found that larger particles no longer settle at the bottom of the heating ink produced by constant stirring. Optionally, a flow enhancer, for example Efka FL 3772 from the company BASF, can also be added, in order to significantly improve the flow behavior of the heating ink at the printheads.

Example: For a specific heating ink mixture,
binder 3% w/w butanol MX 4190,
anti-foaming agent 0.2% w/w Foamstar NO 2306 as well as
conductivity enhancer Efka IO 6780 in a concentration of 0.4% w/w,
anti-settling agent 1.7% w/w Rheovis AS 1130,
carbon 10% w/w Tuball Latex H₂O,
carbon 12% w/w GraphCOND 15/95,
carbon 4% w/w Carbon Black P-XP and
flow modifier 0.8% w/w Efka FL3772
were mixed with 67.9% w/w water.

In order to produce the mixture, a portion of water is first placed in a container and slowly stirred with a paddle. The paddle serves both for stirring and for breaking up any lumps that are added as components or that are temporarily formed in the liquid mixture. Then the anti-foaming agent and the binder are added, preferably followed by the carbon and carbon tetrapods. Finally, or during the stirring process, the remaining water is added to achieve the mixing ratio according to the invention. The heating ink mixture is stirred once again before being poured into the inkjet printer or before the container is inserted into a corresponding slot in the inkjet printer. The inkjet printer can also be equipped with a stirrer that stirs the heating ink mixture during the entire printing process.

A thin heating layer 5 with a thickness of approximately 20 μm was printed onto a nonwoven fabric. A power of 120 W/m² was achieved when connecting the heating surface with a low voltage of 12 volts. The nonwoven fabric has a grammage of 150 g/m² in this experiment.

The heating ink 4 is fluid and can be poured into conventional large-format inkjet printers. This makes it possible to print onto nonwoven fabrics with a width of up to 5.0 meters and a length of up to 50.00 meters or more. The dimensions of the room are programmed in advance into the control system of the large-format inkjet printer. This makes it possible to customize the heating wallpapers 2 to the specific needs of each living space.

The conducting paths 6a, 6b of heating wallpaper 2 are connected with a corresponding wire by a crimp connection, producing the electrical contacts 8a, 8b. The electrical contacts 8a, 8b are covered with a baseboard 12.

FIG. 3 depicts a schematic illustration of the mode of operation of a HP LX850 inkjet printer that was modified compared to the old version. The printhead 13 is connected with two ink-bearing lines 16 that have not been modified and which form a heating ink circuit to generate a consistent ink pressure. The inkjet printer according to the invention has a new holder for the container 14 that holds the invented heating ink. The container 14 is equipped with a paddle stirrer, which stirs the heating ink continuously and slowly during operation. New lines 17 lead from container 14 to a collecting container 18 for heating ink. An old container 14′ and an old line 17′ from the old container 14′ to an old collecting container 18′ have been removed. The printhead 13 draws the heating ink from the collecting container 18 in order to apply it for one of to the aforementioned purposes. The modified inkjet printer has several printheads 13 (not shown), each connected with a container 14 for heating ink. The containers 14 can be filled with different types of heating ink or an ink that forms conducting paths 6a, 6b as described above or an ink that forms an insulating layer between two intersecting conducting paths 6a, 6b, etc. The individual printheads 13 may be controlled via an electronic control system. The print image can be programmed in advance and the heating wallpaper 2 can thus be printed in multiple layers in the specified manner with various types of ink, in particular the heating ink. The new lines 17 have the same cross-section as the old lines 17′.

List of reference symbols

| | |
|---|---|
| 1 | Wall |
| 2 | Heating wallpaper |
| 3 | Heating surface |
| 4 | Heating ink |
| 5 | Heating layer |
| 6a | Conducting path |
| 6b | Conducting path |
| 7 | Net-shaped conducting |
| 8a | Electrical connection |
| 8b | Electrical connection |
| 9 | Door |
| 11 | Window |
| 12 | Baseboard |
| 13 | Printhead |
| 14 | Container |
| 14′ | Old container |
| 16 | Line |
| 17 | Line |
| 17′ | Old line |
| 18 | Collecting container |
| 18′ | Old collecting container |
| B | Width |
| H | Height |

1-22. (canceled)

23. A method for producing a wall heating system, comprising:
determining a printed image of heating surfaces on a heating wallpaper;
gluing the heating wallpaper to a wall; and
connecting the heating wallpaper to an electrical voltage,
wherein:
the printed image is supplied to a control system of an inkjet printer,
the control system is configured to control at least one printhead,
at least one container connected to the printhead in an ink-conducting manner is filled with heating ink, and
the heating ink is printed along the heating surfaces of the heating wallpaper.

24. The method according to claim 23, wherein the wall to be heated is measured, and dimensions of the wall are determined and used to establish the printed image of the heating surfaces.

25. The method according to claim 23, wherein an additional printhead is connected to an additional container in an ink-conducting manner, and the additional container is filled with an additional heating ink that is used to print conducting paths along edges of the heating surfaces.

26. The method according to claim 25, wherein a third printhead is connected to a third container in an ink-conducting manner, and the third container is filled with another heating ink that is used to print net-shaped conducting paths onto the heating surfaces.

27. The method according to claim 25, wherein the conducting paths are glued to the heating wallpaper by applying an adhesive layer on the heating wallpaper and then applying a carbonic conductive layer on the adhesive layer.

28. The method according to claim 27, wherein carbonic powder is sprinkled over the adhesive layer and excess carbonic powder is blown or vacuumed away.

29. The method according to claim 25, wherein the conducting paths are equipped with electrical connectors for a low-voltage power supply.

30. The method according to claim 23, wherein the heating surfaces are printed with a heating layer of uniform thickness over their entire extent and deviations in the thickness of the heating layer do not exceed 10% of the average layer thickness of the respective heating layer.

31. The method according to claim 23, wherein an additional container of an additional printhead is filled with nanotetrapods and the nanotetrapods are fed to the additional printhead via a connecting line and a nanotetrapod layer is printed onto the heating surface with the additional printhead.

32. The method according to claim 31, wherein the nanotetrapod layer is initially printed onto the heating wallpaper and a layer of heating ink is printer over the nanotetrapod layer.

33. The method according to claim 23, wherein the heating ink is printed over the entire surface of the heating wallpaper and the wall to be shielded is fully covered with the heating wallpaper.

34. The method according to claim 23, wherein conducting paths are printed onto the heating wallpaper from power connections to connection points for electrical devices on the heating wallpaper.

35. A liquid heating ink mixture comprising:
0.02% w/w-0.5% w/w anti-foaming agent,
0.05% w/w-90% w/w carbon,
0.05% w/w-40% w/w binder,
40% w/w-80% w/w water, and
0.05% w/w-15% w/w carbon nanotetrapods.

36. The heating ink mixture according to claim 35, wherein the carbon that is not present in the form of nanotetrapods is selected from the group consisting of graphite powder, soot, graphene powder, or nanotubes.

37. The heating ink mixture according to claim 35, further comprising 0.1% w/w-5% w/w anti-settling agent.

38. The heating ink mixture according to claim 35, further comprising 0.1% w/w-5% w/w flow enhancer.

39. The heating ink mixture according to claim 35, further comprising 0.01% w/w-5% w/w conductivity enhancer.

40. A heating wallpaper comprising:
a support sheet; and
at least two conducting paths and a heating surface between them,
wherein the entire heating surface is printed with heating ink made of a heating ink mixture according to claim 35.

41. The heating wallpaper according to claim 40, wherein the at least two conducting paths are applied on the support sheet and the heating ink is printed over the at least two conducting paths.

42. The heating wallpaper according to claim 40, wherein electrical low-voltage connections are mounted at ends of the at least two conducting paths.

43. An inkjet printer with a printhead that is connected with a container in a conductive manner, wherein the container is filled with heating ink made of a heating ink mixture according to claim 35.

44. The inkjet printer according to claim 43, comprising a holder for the container for heating ink and a stirrer that is mounted on the holder and configured to stir the heating ink in the container during a printing process.
